(19) United States
(12) Patent Application Publication
(10) Pub. No.: US 2016/0047754 A1
(43) Pub. Date: Feb. 18, 2016

(54) LIGHT DEFLECTION DETECTION MODULE AND MEASUREMENT AND CALIBRATION METHOD USING THE SAME

(71) Applicant: CHENG MEI INSTRUMENT TECHNOLOGY CO., LTD., Hsinchu County (TW)

(72) Inventor: Cheng-Tao TSAI, Hsinchu County (TW)

(21) Appl. No.: 14/829,165

(22) Filed: Aug. 18, 2015

Related U.S. Application Data
(60) Provisional application No. 62/038,535, filed on Aug. 18, 2014.

(51) Int. Cl. G01N 21/95

(52) U.S. Cl. CPC G01N 21/95; G01N 2201/121

(57) ABSTRACT

A light deflection detection module with a detection stage, a surface light source, at least two scanning cameras and a standard surface is provided. The detection stage is utilized for supporting an object. The surface light source is disposed above the detection stage, and emits a planar light to the detection stage. The at least two scanning cameras are disposed opposite the surface light source. The standard surface is disposed adjacent to the detection stage. When the surface light source emits the planar light to the detection stage, the planar light will be reflected by the surface of the object and the standard surface first, and then received by the at least two scanning cameras. A processor will perform a numerical analysis on the reflected planar light to obtain the detection data and to make the error correction.

This application claims priority to U.S. Provisional Patent Application No. 62/038,535 filed on Aug. 18, 2014.

### CROSS-REFERENCES TO RELATED APPLICATIONS

Not applicable.

### BACKGROUND OF THE INVENTION

1. Field of the Invention

The present invention relates to a light deflection detection module and a measurement and calibration method using the same, and more particularly, to a measurement and calibration method using a light deflection detection module with a standard surface.

2. Descriptions of the Related Art

In the prior art, methods for detecting the surface of an object with a substantially flat surface, e.g., a wafer, can generally be divided into the following two categories: (1) disposing one sensor at the upper surface and the lower surface of the wafer respectively so that the two sensors are right opposite to each other with the wafer sandwiched therebetween, then simultaneously moving the two sensors to measure variations of the upper surface and the lower surface on the vertical axis, thereby obtaining related measurement data; and (2) adsorbing the lower surface of the wafer that is flattened by a vacuum adsorption device, and then using a detecting device to detect the upper surface of the wafer to obtain related detection data.

Although the devices and elements required in the method for detection by adsorbing the flattened wafer are simplified as compared to those required in the method for detecting by measuring the upper surface and the lower surface of the wafer respectively with two sensors, a disadvantage of the method for detecting by adsorbing the flattened wafer lies in that the error of the bearing surface of a detection stage for placing a wafer thereon relative to the virtually horizontal plane usually has a great influence on the subsequent detection result.

Since the aforesaid detection stage also serves to adsorb the flattened wafer, the detection stage can also be provided with a plurality of vacuum adsorption grooves arranged in a circle to assist in adsorbing the lower surface of the wafer as a second way for detecting the surface, as is known by those skilled in the art.

Then, since the vacuum adsorption grooves arranged in a circle make the bearing surface of the detection stage subtly irregular and uneven, it is difficult for the detection device to detect the error of the bearing surface relative to the virtually horizontal plane in advance, which would greatly affect the subsequent detection result.

Accordingly, it is important to provide a detection module for use in a method for detection by adsorbing the flattened wafer, which can assist in detecting the error of the bearing surface of the detection stage relative to the virtually horizontal plane in advance so that error correction on the surface can be made in the subsequent process of detecting the upper surface of the wafer and performing a numerical analysis.

### SUMMARY OF THE INVENTION

An objective of the present invention is to provide a light deflection detection module with a standard surface that can be used as a reference plane during the detection of a surface of an object to facilitate the subsequent detection and error correction.

To achieve the aforesaid objective, a light deflection detection module of the present invention comprises a detection stage, a surface light source, at least two scanning cameras and a standard surface. The detection stage is adapted to support the object. The surface light source is disposed above the detection stage and emits a planar light to the detection stage. The at least two scanning cameras are disposed opposite the surface light source. The standard surface is disposed adjacent to the detection stage. When the surface light source emits the planar light to the detection stage, the planar light will be reflected by the surface of the object and the standard surface first and then received by the at least two scanning cameras. A processor is adapted to perform a numerical analysis on the reflected planar light to obtain the detection data and to make the error correction.

To achieve the aforesaid objective, the detection stage comprised in the light deflection detection module of the present invention further comprises a vacuum adsorption part for fixing the object through adsorption.

To achieve the aforesaid objective, the planar light emitted by the surface light source comprised in the light deflection detection module of the present invention is a visible light or an invisible light.

To achieve the aforesaid objective, the planar light emitted by the surface light source comprised in the light deflection detection module of the present invention is a plurality of moiré images.

To achieve the aforesaid objective, the at least two scanning cameras comprised in the light deflection detection module of the present invention are plane scanning cameras.

To achieve the aforesaid objective, the standard surface comprised in the light deflection detection module of the present invention is disposed independent of the detection stage.

To achieve the aforesaid objective, the standard surface comprised in the light deflection detection module of the present invention extends from the detection stage.

To achieve the aforesaid objective, the standard surface and the detection stage comprised in the light deflection detection module of the present invention are formed simultaneously so that the standard surface and the detection stage have the same surface height or surface inclination.

To achieve the aforesaid objective, the planar form of the standard surface comprised in the light deflection detection module of the present invention is a rectangular form, a circular form or a polygonal form.

To achieve the aforesaid objective, the standard surface comprised in the light deflection detection module of the present invention has an area of greater than or equal to 1 mm×1 mm.

To achieve the aforesaid objective, the object comprised in the light deflection detection module of the present invention is a 4-inch, 6-inch or 8-inch wafer.

To achieve the aforesaid objective, the present invention further comprises a method for detecting and making error correction on a surface of an object, which comprises the following steps: (a) providing a light deflection detection module; (b) adsorbing the object to be flattened by a vacuum adsorption part of a detection stage; (c) emitting a planar light from a surface light source to the surface of the object that is adsorbed to be flat and a standard surface disposed adjacent to the detection stage; (d) receiving the planar light reflected from the surface of the object and the standard surface via the at least two scanning cameras; and (e) analyzing the planar light reflected from the surface of the object and the planar light reflected from the standard surface respectively by a processor to obtain an error therebetween and to make the error correction.

To achieve the aforesaid objective, the planar light emitted by the surface light source used in the method for detecting and making error correction of the present invention is a plurality of moiré images.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a light deflection detection module according to the present invention;

FIG. 2 is a schematic view of a detection stage of the light deflection detection module according to the present invention;

FIG. 3 is a schematic view of another detection stage of the light deflection detection module according to the present invention; and

FIG. 4 is a flowchart diagram of a method for detecting and making error correction on the surface of an object according to the present invention.

### DESCRIPTION OF THE PREFERRED EMBODIMENT

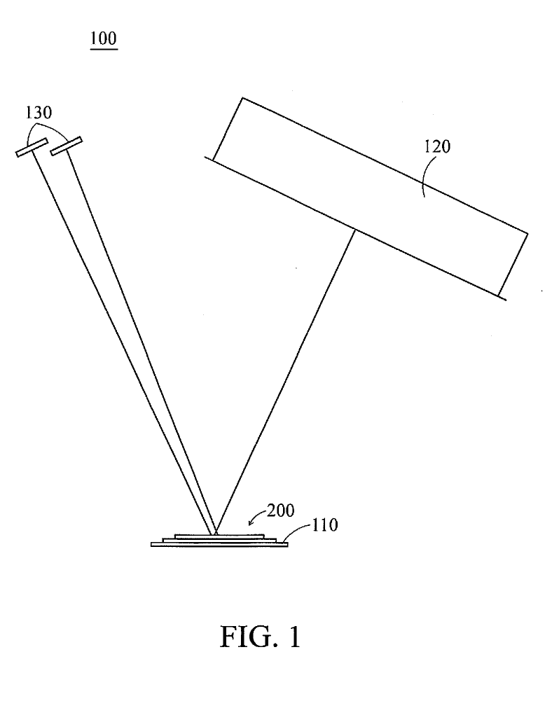

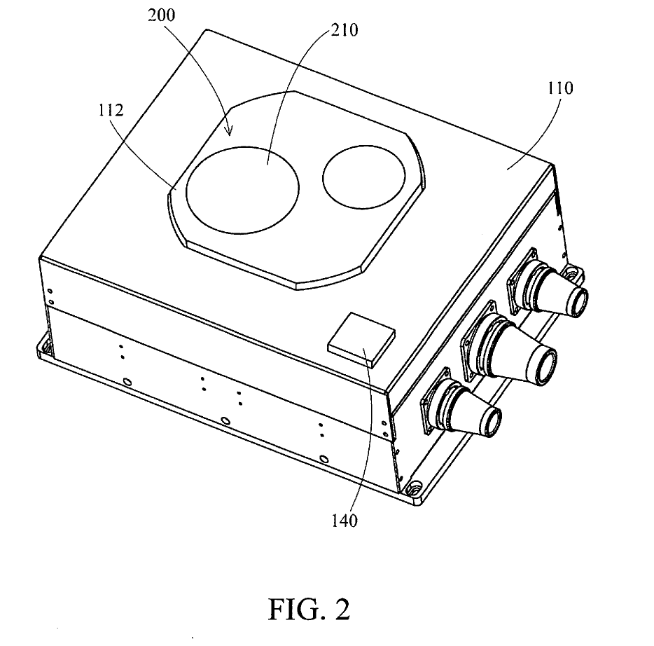

With reference to both FIGS. 1 and 2 together, the present invention provides a light deflection detection module 100 with a standard surface 140, and the standard surface 140 can be used as a reference plane during the detection of a surface 210 of an object 200 so that a processor (not shown) can perform the subsequent detection and error correction.

In detail, as shown in FIG. 1, the light deflection detection module 100 of the present invention comprises a detection stage 110, a surface light source 120, two scanning cameras 130 and a standard surface 140. The detection stage 110 is adapted to support the object 200. The surface light source 120 is disposed above the detection stage 110 and emits a planar light to the detection stage 110. The two scanning cameras 130 are disposed opposite the surface light source 120, and the standard surface 140 is disposed adjacent to the detection stage 110.

As shown in FIG. 2, when the surface light source 120 emits the planar light to the detection stage 110, the planar light will be reflected by the surface 210 of the object 200 and the standard surface 140 at one side first and then received by the two scanning cameras 130 disposed opposite the surface light source 120. A processor is adapted to perform a numerical analysis on the reflected planar light to obtain the detection data and to make the error correction.

Hereinafter, the detection operation of the light deflection detection module 100 of the present invention will be described as follows.

First, since the detection stage 110 of the light deflection detection module 100 of the present invention comprises a vacuum adsorption part 112, the detection stage 110 will be able to fix the object 200 through adsorption by the vacuum adsorption part 112 when the object 200 is for example, a 4-inch, 6-inch or 8-inch wafer. Such an operation, in which the lower surface of the object 200 is adsorbed by the vacuum adsorption part 112 so that the lower surface of the object 200 is completely flattened and attached to the detection stage 110, is the so-called “adsorbed to be flattened” step.

Then, the surface light source 120 emits the planar light to the detection stage 110. The surface 210 of the object 200 and the standard surface 140 can thus reflect the planar light respectively so that the reflected planar light can be received by the two scanning cameras 130.

Finally, the processor analyzes the planar light reflected from the surface 210 of the object 200 and the planar light reflected from the standard surface 140 respectively and performs a numerical calculation. The subsequent error correction according to the error value calculated from the planar light reflected from the standard surface 140 is then done to obtain the correct detection data.

It shall be appreciated that in the preferred embodiment of the present invention, the planar light emitted by the surface light source 120 not only can be a visible light or an invisible light but also can be a plurality of moiré images so that corresponding images can be provided for numerical analysis performed by the processor depending on different detection demands.

In the preferred embodiment of the present invention, both the two scanning cameras 130 are plane scanning cameras. However, the number of scanning cameras 130 actually may be adjusted to be three, four, or even more depending on different detection demands, and no limitation is made thereto. However, it shall be noted that the number of the scanning cameras 130 should be at least two, and the two scanning cameras 130 are disposed at two different positions. The reason lies in that fixing the two scanning cameras 130 above the detection stage 110 and opposite the surface light source 120 allows the two scanning cameras 130 to receive the planar light reflected from the surface 210 of the object 200 and the standard surface 140 conveniently. The two scanning cameras 130 are disposed at two different positions allows for receiving the reflected planar light respectively at the two different positions and then taking an average to improve the accuracy of the subsequent numerical analysis.

As shown in FIG. 2, in the preferred embodiment of the present invention, the standard surface 140 of the light deflection detection module 100 is disposed independent of the detection stage 110 to assist in reflecting the planar light of the surface light source 120 so that error correction can be subsequently performed by the processor.

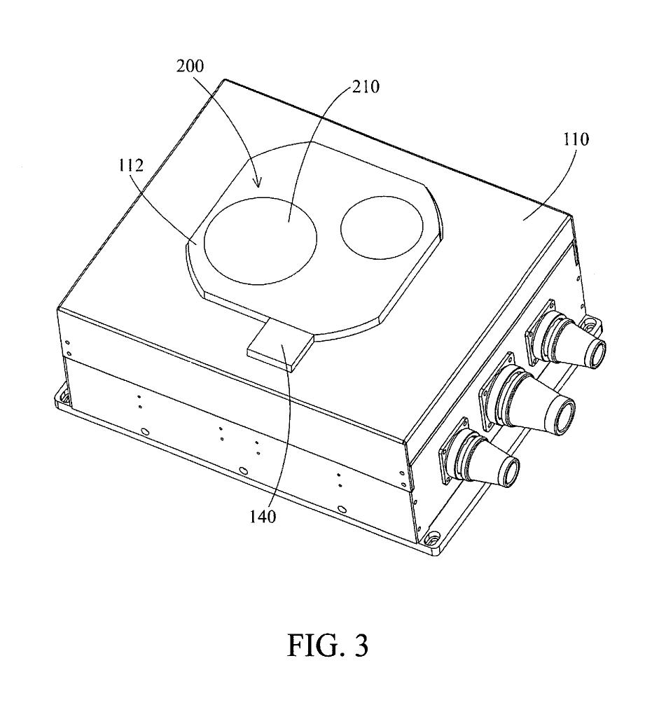

However, as shown in FIG. 3, the standard surface 140 of the light deflection detection module 100 may also extend from the detection stage 110. In this case, the standard surface 140 can also assist in reflecting the planar light of the surface light source 120 so that error correction can be subsequently performed by the processor.

Whether the standard surface 140 is disposed independent of the detection stage 110 as shown in FIG. 2 or extends from the detection stage 110 as shown in FIG. 3, the standard surface 140 and the detection stage 110 shall be formed simultaneously so that the standard surface 140 and the detection stage 110 have the same surface height or surface inclination.

Although the standard surface 140 is in a circular form in the drawings of this application, the standard surface 140 is not limited thereto. In other words, the standard surface 140 may also be in a triangular form, a rectangular form, or other polygonal forms.

In this application, the area of the standard surface 140 depends on the resolution of the scanning cameras 130. However, in the preferred embodiment, the standard surface 140 has an area of greater than or equal to 1 mm×1 mm, which can facilitate the scanning of the scanning cameras 130 and speed up the numerical analysis of the processor.

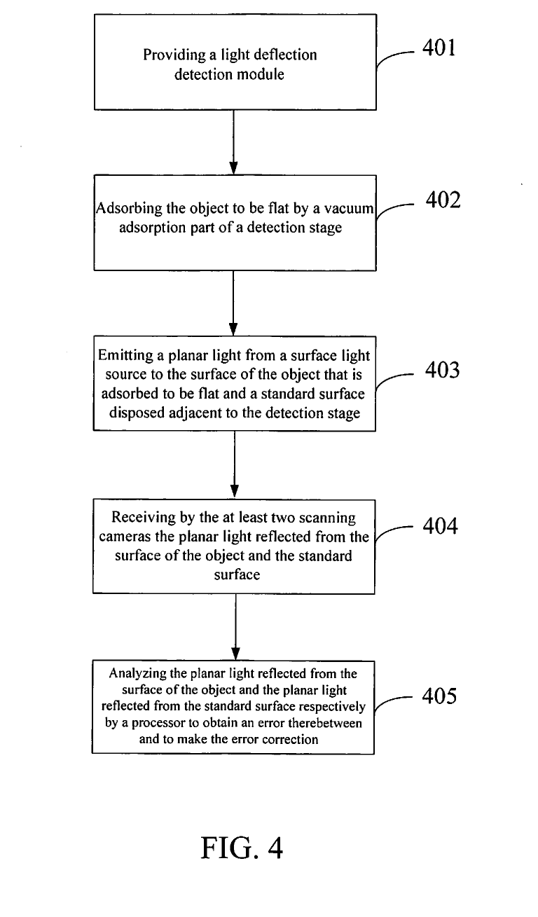

As shown in FIG. 4, the present invention further comprises a method for detecting and making error correction on a surface 210 of an object 200, which comprises the following steps: (a) providing a light deflection detection module 100, as shown in step 401; (b) adsorbing the object 200 to be flattened by a vacuum adsorption part 112 of a detection stage 110, as shown in step 402; (c) emitting a planar light from a surface light source 120 to the surface 210 of the object 200 that is adsorbed to be flattened and a standard surface 140 disposed adjacent to the detection stage 110, as shown in step 403; (d) receiving the planar light reflected from the surface 210 of the object 200 and the standard surface 140 via the two scanning cameras 130, as shown in step 404; and (e) finally analyzing the planar light reflected from the surface 210 of the object 200 and the planar light reflected from the standard surface 140 respectively by a processor to obtain an error therebetween and to make the error correction, as shown in step 405.

The planar light emitted by the surface light source 120 is a visible light, an invisible light, or a plurality of moiré images so that the most suitable planar light for determining the flatness and drawbacks (e.g., cracks) of the surface 210 of the object 200 can be provided depending on different detection demands.

According to the above descriptions, through the arrangement of the standard surface 140 of the present invention, when the object 200 is adsorbed to be flattened on the detection stage 110 and then detected, the planar light reflected from the surface 210 of the object 200 and the planar light reflected from the standard surface 140 can be obtained simultaneously simply by emitting the planar light only once. Thereafter, the planar light reflected from the standard surface 140 is numerically analyzed by the processor to obtain error correction data. The error correction data is then used together with the detection data, which is obtained from the numerical analysis performed by the processor on the planar light reflected from the surface 210 of the object 200, in the error correction to make the detection result accurate. That is, through the arrangement of the standard surface 140 of this application, the detection of the plane of the object and the related error correction can be completed simply by emitting the planar light only once, which effectively reduces the time required for the detection and improves the detection efficiency and the detection accuracy.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A light deflection detection module for detecting and making error correction on a surface of an object, comprising:
a detection stage, being adapted to support the object;
a surface light source disposed above the detection stage, being adapted to emit a planar light to the detection stage;
at least two scanning cameras disposed opposite the surface light source; and
a standard surface disposed adjacent to the detection stage;
wherein when the surface light source emits the planar light to the detection stage, the planar light will be reflected by the surface of the object and the standard surface first and then received by the at least two scanning cameras, and a processor will perform a numerical analysis on the reflected planar light to obtain the detection data and to make the error correction.

2. The light deflection detection module of claim 1, wherein the detection stage further comprises a vacuum adsorption part for fixing the object through adsorption.

3. The light deflection detection module of claim 1, wherein the planar light emitted by the surface light source is a visible light or an invisible light.

4. The light deflection detection module of claim 1, wherein the planar light emitted by the surface light source is a plurality of moiré images.

5. The light deflection detection module of claim 1, wherein the at least two scanning cameras are plane scanning cameras.

6. The light deflection detection module of claim 1, wherein the standard surface is disposed independent of the detection stage.

7. The light deflection detection module of claim 1, wherein the standard surface extends from the detection stage.

8. The light deflection detection module of claim 1, wherein the standard surface and the detection stage are formed simultaneously so that the standard surface and the detection stage have the same surface height or surface inclination.

9. The light deflection detection module of claim 1, wherein the planar form of the standard surface is a rectangular form, a circular form or a polygonal form.

10. The light deflection detection module of claim 1, wherein the standard surface has an area of greater than or equal to 1 mm×1 mm.

11. The light deflection detection module of claim 1, wherein the object is a 4-inch, 6-inch or 8-inch wafer.

12. A method for detecting and making error correction on a surface of an object, comprising the following steps of:
(a) providing a light deflection detection module of claim 1;
(b) adsorbing the object to be flat by the vacuum adsorption part of the detection stage;
(c) emitting the planar light from the surface light source to the surface of the object that is adsorbed to be flat and the standard surface;
(d) receiving by the at least two scanning cameras the planar light reflected from the surface of the object and the standard surface; and
(e) analyzing the planar light reflected from the surface of the object and the planar light reflected from the standard surface respectively by the processor to obtain an error therebetween and to make the error correction.

13. The method of claim 12, wherein the planar light emitted by the surface light source is a visible light or an invisible light.

14. The method of claim 12, wherein the planar light emitted by the surface light source is a plurality of moiré images.
